(19) United States
(12) Patent Application Publication
(10) Pub. No.: US 2004/0065075 A1
(43) Pub. Date: Apr. 8, 2004

(54) Ultraviolet light curable rocket motor liner

(76) Inventors: Heather M. Peterson, Ogden, UT (US); Merylin B. Lovett, Ogden, UT (US)

Correspondence Address: PARSONS BEHLE & LATIMER, PATENT SECTIONS ATK, P.O. BOX 45898, SALT LAKE CITY, UT, 84145-0898, US

(21) Appl. No.: 10/264,763

(22) Filed: Oct. 4, 2002

(51) Int. Cl. F02K 9/08

(52) U.S. Cl. 60/253

(57) ABSTRACT

An ultraviolet curable bond liner with a high filler content that is curable sufficiently for casting of the propellant by exposure to ultraviolet light at a wavelength between 350 and 400 nm. By irradiating the liner at this wavelength, the initiator can be activated without interference from the filler components or heat cured liner components. After the casting of the propellant, the bond liner is heat cured along with the propellant.

### CROSS REFERENCE TO RELATED APPLICATIONS

(Not applicable)

### Federal Research Statement

(Not applicable)

### BACKGROUND OF INVENTION

Solid rocket motors typically comprise a rigid outer casing containing an inner solid propellant grain. In order for the motor to function properly, the propellant grain must be securely bonded to the casing wall to limit the exposed surface area of the propellant, and the inner casing wall must be protected from the heat of the burning propellant to prevent casing failure. In a typical application, an elastomeric bond liner is used to bond the propellant grain to the casing wall. In some rocket motors, an insulation layer is first applied to the casing wall and a bond liner is used to bond the propellant grain to the insulation layer.

In addition to bonding the insulation to the casing wall, the bond liner is used as an insulator, which allows reduction or elimination of the separate insulation layer. For this function, the bond liner must also be capable of withstanding the high temperature and high velocity gases produced when the propellant grain burns to protect the casing. Accordingly, the bond liner usually contains flame retardant solid fillers. Other requirements must also be met for certain applications. For example, in the manufacture of rocket motors with low signature properties, any smoke producing materials are minimized and fillers are chosen that minimize the production of smoke and like signature materials. This requires the use of fillers in the bond liner that are both insulative and have a low signature. Examples of such low signature bond liners are disclosed in U.S. Pat. No. 6,054,521, which discloses borate and metal oxide fillers.

The bond liner is usually applied by spraying a heat curable composition upon the inner surface of the casing. In order to prevent unwanted liner flow before and during casting of the propellant, the liner must be partially cured or gelled. The partial curing or precure cures the composition sufficiently to resist gravity and the flow of the propellant during casting, and to also to resist vacuum induced bubbling caused by trapped volatiles. In addition, the composition generally requires a thixotrope added as a solid filler to prevent slumping during the partial curing. A thermally or heat activated curing catalyst is also usually added to speed the initial curing.

The thermal activation of the bond liner to cure it to a gel state usually takes several hours to several days and must be done in large curing ovens. After the liner is partially cured, the propellant is cast into the lined rocket casing, and the liner is fully cured when the propellant is cured by heating the motor.

Thus, a liner composition must undergo two separate curing steps during the motor manufacture, an initial gel cure before casting of the propellant and a final cure after the casting. In the heat cured liner compositions, the chemistry for both curing steps is usually the same, with the first step carried out to the point where the liner is not fully cured but sufficiently cured for the casting. An example of such bond liner systems is one comprising an hydroxyl-terminated elastomer based polyurethane, such as that derived as the reaction product of a hydroxyl terminated polybutadiene prepolymer and a polyisocyanate curing agent.

Because of the inordinate length of time required for the first precure of the liner, there have been efforts to shorten or eliminate this step. One approach that has been suggested involves the use of a bond liner system that is initially curable by ultraviolet (UV) light. A UV curable system potentially has the advantage of a faster and better control of the precure. The UV curing reaction only occurs when the dormant UV initiator is activated by the correct UV wavelength, which initiates the formation of a radical polymer which crosslinks with itself in seconds. Such systems are disclosed in U.S. Pat. No. 5,031,539 to Hutchens (Hutchens), and U.S. Pat. No. 5,377,593 to Boothe et al. (Booth et al.) The Hutchens patent discloses a liner composition comprising a photocurable acrylated polymer, [[[(isocyanatoorgano)amino]carbonyl]oxy] alkyl propionate. The [[[(isocyanatoorgano)amino]carbonyl]oxy] alkyl propionate provides both an acrylate site for photocuring the polymer for the initial precure, and an isocyanate site for thermal reaction with the propellant binder during the final cure. While this formulation may be successful in bonding the propellant grain to an insulation layer, it would be unsuitable for the current practice where the bond liner functions as an insulator. This is because the Hutchens formulation contains no fillers. A likely reason is that fillers are often opaque and interfere with the penetration of the ultraviolet light into bond liner layer, which would result in a surface UV cured or partially cured liner that would not adhere to the case wall.

The Boothe et al. patent discloses a formulation comprising an ultraviolet curable polymer and a thermally curable polymer that forms an interpenetrating network of the photo- and thermal-curable polymers. Boothe et al. discloses the use of up to 50% of a filler that preferably does not absorb ultra-violet radiation, and can be selected from silica, calcium carbonate and dicyandiamide. The only working example shows a filler of dicyandiamide in an amount of 24%. Boothe et al. discloses the basic concept of using UV curable formulations for bond liners, but the compositions disclosed are limited in their applicability and cannot be used in commercially viable systems. For a formulation to be commercially viable, it must contain conventionally known filler materials for insulative and fire resistance properties. The only filler actually used in Boothe et al. is dicyandiamide, which is not a filler that has ever been conventionally used in rocket motor bond liner formulations. This material melts at 209° C., and without any other material to sinter with and form a char, it would be expected that it would provide little or no insulative property to the liner. In Booth et al. it is believed that the principal reason that this filler was chosen was mainly its lack of opacity. Generally, a bond liner formulation would be expected to include fillers with known and commercially viable properties as fillers, such as those discussed above. But these fillers here are excluded, and only by a careful and unusual selection of fillers is it believed possible to make a UV-curable bond liner according to the teachings of Boothe et al.

A commercially successful bond liner must be curable and be able to contain conventional fillers, such as flame retardant, erosion resistant, and thixotrope fillers used in present heat curable bond liners. In addition, the solid content of these fillers must be high as in current heat curable liners, e.g. 50 to 60 weight percent, in order for the bond liner to have suitable properties. Currently, UV formulations have been unable to fill these requirements.

A large problem with using fillers in UV bond liner formulations, is that many fillers are basically opaque at the UVB frequencies at which prior-art formulations have been activated. This is a particular problem with bond liners for rocket motors because of the high filler content. This contrasts with UV curable formulations used for coatings and the like where compensation for increased opacity from fillers can be made by increasing the power of the UV light source. However, these UV curable coatings generally only have solid contents around 10 percent and less. Using this approach for rocket motor bond liner compositions, which would require up to 60 percent solids, is probably not possible and at best not practical. Accordingly, the Booth et al. approach was to carefully contrive the filler to have high transparency. But even with his specially chosen filler, only a modest filler content was achieved. The result is that the Boothe et al. approach of limiting the content and composition was made at the expense of bond liner properties. Basically, the choice of a filler for use in UV-curable bond liner formulations as in Booth et al. is so strongly governed by its transparency and effect on the UV curing that only unusual fillers in limited amounts can be used, which eliminates the use of known fillers with advantageous properties. For this reason, UV-curable bond liners have not had the insulative, erosion, flame retardant and other properties that are required for many bond liner applications

Another problem with the Booth et al, is that even with its compromised filler system, multiple UV polymers are required to achieve practical cure depths of the bond liner. For this reason it is believed that the Boothe et al. formulation comprises a UV-curable polymer with an optional ultraviolet reactive diluent. The diluent, although described as “optional”, for practical reasons is required, because the double bonds in the UV-curable polymer absorb the UV light in the UVB region, where the initiator in the Booth et al. bond liner formulation is activated. Thus to increase the transparency of the formulation to further the already limited use of fillers, it is believed that the diluent was added. The diluent may have also been added in the belief that such will decrease the cross-linking and increase the flexibility of the bond liner. However, from subsequent studies, it has been found that diluents have only minor effect in this regard and may actually degrade bond liner properties. Basically, this further illustrates the lengths of compromise that must be made with a Boothe et al. system to maintain transparency and curability of the composition with only a moderate filler content. Yet even with these measures, only a compromised bond liner composition with inferior properties can be produced.

The following patents contain background information and are accordingly incorporated by reference:

U.S. Pat. No. 4,429,634, to Byrd et al., issued Feb. 7, 1984,

U.S. Pat. No. 4,601,862, to Byrd et al., issued Jul. 22, 1986,

U.S. Pat. No. 4,604,248, to Dehm, issued Aug. 5, 1986,

U.S. Pat. No. 4,736,684, to Byrd et al., issued Apr. 12, 1988,

U.S. Pat. No. 4,803,019, to Graham et al., issued Feb. 7, 1989,

U.S. Pat. No. 5,031,539, to Hutchens, issued Jul. 16, 1991,

U.S. Pat. No. 5,056,405, to Davidson et al., issued Oct. 25, 1991,

U.S. Pat. No. 5,377,593, to Boothe et al., issued Jan. 3, 1995, and

U.S. Pat. No. 6,054,521, to Nelson, et al., issued Apr. 25, 2000.

### SUMMARY OF INVENTION

The present invention involves a method and composition for a rocket motor bond liner with a UV curable polymer for the initial precure and heat curable polymer for the final cure after casting the propellant. The bond liner composition of the invention has a high tolerance for fillers with flame retardant and low signature properties, allowing a high content of these fillers. The UV curable polymer is formulated to be activated in the UVA wavelength region between about 350 to about 400 nm. Activation at this wavelength allows the use of fillers that previously have not been usable in UV bond liners.

It has been found that certain fillers cannot be used in previous formulations because of their opacity in the UVB region, but that these fillers can be used in UV-curable bond liners that are cured in the UVA region. The interference of the filler in this region is minimized to the degree that effective curing can be accomplished without undue UV absorption and interference to the curing.

It has also been found that not only can fillers be used that were previously unusable, but that the filler content be as high as 50-60 wt. %, which is significantly higher than was previously possible in UV curable bond liner compositions. The bond liners of the present invention provide these advantages while providing excellent bondline properties between the bond liner and commonly used composite propellants, such as, for example, 1.3 nitrate ester propellants.

The bond liner of the invention is cured to a slump resistant state within seconds of exposure to UVA radiation, but it is not affected by standard overhead or fluorescent lighting and has a pot life exceeding eight hours in its non-irradiated state. Propellant can be cast directly into the motor following liner irradiation without multi-day pre-cure cycles or the large ovens required for the thermally activated binder system. The thermal portion of the liner cure is then activated and fully cured during the propellant cure cycle.

There are other advantages that can be realized by the practice of the invention in addition to the radically reduced cure time when compared to thermally activated cure systems. Since a cure time less than one minute can be realized, there is a reduction in handling and there are no separate curing ovens. Since the UV composition requires UV light to cure, the polymer retains a low viscosity until it is applied and cured. This eases the application of the resin, and results in a longer pot life. The heat curable polymer component of the invention does not require curing during the precure. Accordingly, curing catalysts that were used in heat curable systems to assist in the precure, but also reduced the pot life, are not usually required in the present invention. The low viscosity retained by the composition of the invention allows better control during application of the liner to the casing wall, and allows for a thinner liner. This is an important advantage in rocket motors where weight is an important consideration.

The UV curable liner formulation of the present invention combines desirable aspects of free radical and thermal or heat curing systems. The free radical polymer and initiator provide a mechanism for a quick, controlled precure to prepare the motor for propellant casting. The heat curable polymer supplies the material strength and strain necessary for binding to the propellant. An exemplary formulation comprises a heat-activated polymer and curative, a UV-activated acrylate polymer and UVA sensitive initiator. A filler of UV-transmittive fillers comprising UV transparent and UV-semitransparent fillers for erosion resistance, and a thixotrope for rheological control.

### BRIEF DESCRIPTION OF DRAWINGS

FIG. 1 is a flow sheet illustrating an aspect of the present invention.

### DETAILED DESCRIPTION

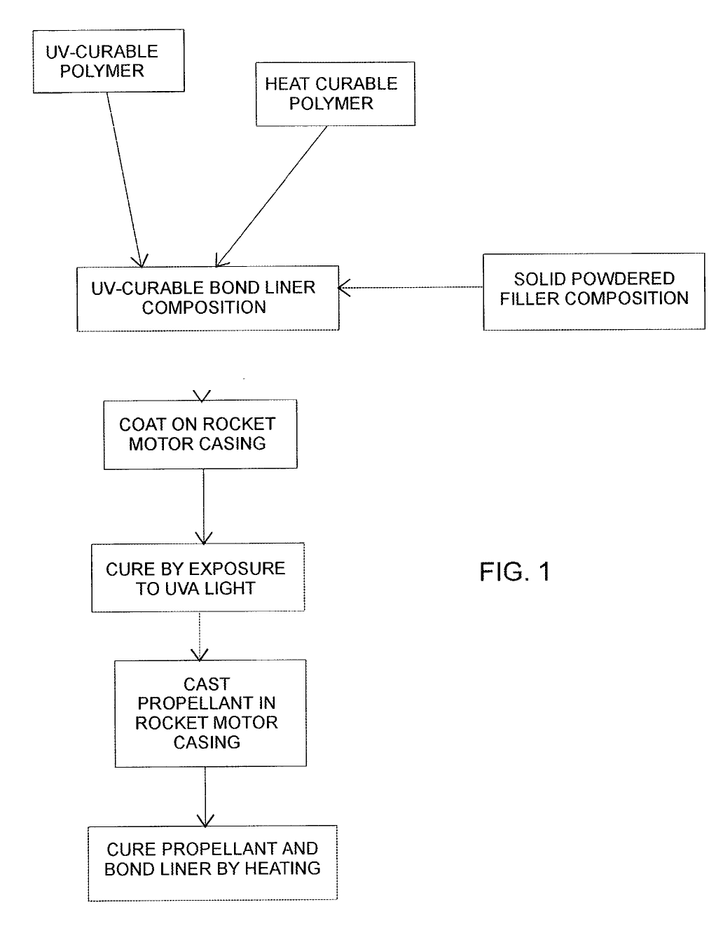

Referring to FIG. 1, which is a flow sheet illustrating an aspect of the present invention. A UV-curable bondliner composition is provided as an admixture of three components; (1) a UV-curable polymer, (2) a heat curable polymer, (3) and filler. The composition is a high filler composition having at least 30 weight percent filler, preferably 40 to 60 weight percent filler, with the remaining portion being the UV-curable polymer and the heat curable polymer.

The ratio of the UV-curable polymer to the heat curable polymer is any suitable quantity, and is chosen such that after the UV curing step the liner is sufficiently cured to stay in place during propellant casting, (which may be under vacuum). The UV polymer and initiators are more expensive than heat cure polymers, so it is desired to keep the ratio as low as possible while still achieving suitable results. A ratio of 40/60 for the formulation shown in the examples has been found suitable. At this ratio the UV cure solidifies the liner to the point of no slump (no observable movement after 24 hours on a vertical plate at ambient temperature), permitting the propellant to be cast. If the UV polymer is in too low of an amount the liner is left too under-cured and will not stay in place during casting of the propellant.

The UV-curable polymer may be any suitable UV-curable polymer system that is curable by exposure to light in the UVA range, i.e., in the wavelength between about 350 and about 400 nm. The UV-curable polymer is preferably an acrylate, free-radical curable polymer with an appropriate free-radical initiator that is activated by exposure to light in the UVA range.

The initiator should have an activation peak the UVA range. An example of a suitable free radical initiator is phenylbis(2,4,6-trimethylbenzoyl)-phosphone oxide, which is a bleaching photoinitiator available under the name Irgacure-819™ from Ciba Specialty Chemicals. This initiator has a low intensity absorption peak in the UVA region. Since many initiators are not generally intended for activation in the UVA range, care must be taken that an initiator be chosen that has an absorption/activation peak in that region.

The heat curable polymer portion of the formulation of the invention is any suitable thermally curable binder composition suitable for rocket motor binder applications, particularly for bond liner compositions. The heat curable polymer is chosen to be compatible with the UV-curable polymer and to chemically match propellant binder to ensure an acceptable bond between the propellant and bond liner. Such binder compositions suitable for use in rocket motor binder applications include, for example, polyurethanes, polysulfides and epoxies. A frequently used binder composition comprises a polymer having reactive hydroxy or thiol groups, or their chemical equivalent. The binder can comprise, for instance, a urethane system with a prepolymer binder with reactive hydroxy functionality (or chemical equivalent) and a curative. The pre-polymer binder can be from the class of organic compounds having at least two reactive hydrogen providing moieties, preferably hydroxy or thiol moieties, capable of reacting with a polyisocyanate to form urethane or thiourethane linkages. The pre-polymers can include hydroxy or equivalent functionalized polybutadienes, polyethylene oxides, and polyesters, among others. Suitable prepolymers are hydroxy terminated polybutadiene (HTPB) polymers. The amount of curing agent selected will be governed by its functionality and the amount of binder, and can thus be characterized as being used in an amount effective for curing the heat curable polymer component of the binder. Indeed, the amount of curative is, in general, unique to a specific polymer. Curing agents typically include at least one multifunctional isocyanate, usually a diisocyanate. Suitable curing agents include, for example, m-tetramethyl xylene diisocyanate (TXMDI), isophorone diisocyanate (IPDI), dimeryl diisocyanate (DDI) biuret triisocyanate, and toluene 2,4-diisocyanate (TDI).

The heat curable polymer requires activation only during the final curing when the binder is cocured with the propellant grain. Since no thermal curing is required, or even desired, during the precure phase a catalyst to promote thermal cure is usually not required. However, for some requirements a catalyst may be desirable, and may be any suitable catalyst known in the art.

The filler is chosen to have properties required for the bond liner, the function of which is mainly to impart erosion resistance to the bond liner during operation of the rocket motor. In summary, desired properties of fillers include flame retardancy, good ablation and erosion properties, a low production of observable smoke, and the like. The filler may also have other functions, such as a rheological modifier for liquid application (thixotrope).

The filler should be “UV-transmittive”, or should have “UV-transmittance” which herein means that the fillers together as whole transmit light sufficiently without excessive scattering or absorption or are sufficiently transparent or clear at the activation UVA frequency such that the activating UV light penetrates adequately through the bond liner layer to essentially provide a full cure of UV curable polymer in the entire layer. UV-transmittance refers to the filler as a whole, and not to the properties of an individual constituent. Thus, for example, a constituent may be present in a minor or small amount in a suitably UV-transmittive filler, even though the same constituent would render the filler non-UV-transmittive if present in a major amount. Other factors, that affect UV-transmittance include the thickness of the bond liner layer to be cured, the intensity of the UV light source at the activating wave length, and the particular curing properties of the initiator/polymer system used. The screening and testing of fillers for suitable UV-transmittance in the compositions of the present invention and their effect on the curing of the bond liner can be determined by routine experimentation. As, an example, a composition of the invention with filler composition with a loading of 50 wt. % and a thickness of 95 to 100 mils has been found to cure within 20 to 60 seconds if the filler is UV-transmittive. In addition, certain fillers with constituents having a refractive index of 1.3 to 1.5 have often been found suitably UV-transmittive, and certain fillers with a large amount of filers with a refractive index of about 2 have been found unsuitable.

Suitable fillers constituents include those commonly used as bond liner fillers, and include, for example, salts of low molecular weight metals, aluminum trihydrate (ATH), zinc borate, magnesium salts, such as Mg(OH)₂, silicon based compounds, such as amorphous and crystalline silicas, and silica thixotropes (e.g. Cab-O-Sil™).

In an aspect of the invention, the fillers that are of the low signature (low smoke) type are used as components of the filler. Examples of such fillers include those disclosed in U.S. Pat. No. 6,054,521. These include zinc borate (e.g., 2ZnO.3B₂O₃.3.5H₂O) fillers, and metal oxide fillers, such as alumina trihydrate. Titanium dioxide, because of its UV absorption properties, will generally not be used or used only in small amounts as a filler constituent in the present invention.

Still other filler materials can additionally be included in the liner formulation to meet the requirements of a specific motor system. Illustrative additional or auxiliary fillers may include, among others, silicon dioxide, ammonium polyphosphate, and possibly diammonium phosphate.

Among the filler constituents that may optionally be added is any filler material that can function as a thixotrope to control and tailor the rheology of the liner formulation. The thixotrope can be present in the formulation in an amount sufficient to effect the desired rheological modification to the uncured liner formulation. In general, a constituent functioning as a thixotrope can be included in the binder formulation in an amount of about 1-3% by weight, relative to the total weight of the liner formulation. The actual amount can be varied depending on the type of thixotrope selected. An exemplary thixotrope comprises fumed silica oxide, manufactured by Mallinkrodt Baker, Inc. under the trade name CAB-O-SIL™, which in general is of a smaller average particle size (such as 0.05 to less than 1 micron) than a silicon dioxide which can be used as a non-erosion, insulative filler. Other thixotropes include, for instance poly substituted sorbitols or some organic waxes or oil derivatives, such as THIXCIN-E.

The liner formulation may also include materials to increase the compatibility of the filler with the UV and heat curable polymers. For example, lithium-salt fillers, which are UV-transmittive, but are frequently difficult to wet in some polymer systems may require the addition of a suitable surfactant or wetting agent.

The liner formulation can, if desired, also include at least one bonding agent or bond promoter. These are typically mobile, reactive ingredients which diffuse from the liner into the interfacial propellant and react with the oxidizer, such as an ammonium perchlorate oxidizer, propellant binder or other propellant ingredients to enhance bondline properties. Exemplary bond promoters include, for instance, di- and tri-functional aziridine (i.e., cyclic ethylene imines) compounds. Suitable cyclic imines include, by example 1,1-[1,3-phenylene dicarbonyl bis(2-methylaziridine)] and trimesoyl 1-(2-ethyl) aziridine. These materials can be included in the formulation in amounts effective to enhance bondline strengths.

The uncured UV-curable bond liner composition is applied to the inside surface of a rocket motor casing by coating the casing with the liner formulation and then curing the liner formulation by exposure to UV light. The liner can be coated to the interior surface of the rocket motor by such techniques as spraying, brushing (including hand brushing), slush lining, and rotary atomization (“sling lining”).

The bond liner composition can be applied to any conventional rocket motor casing material, such as steel, aluminum, and composite materials. In addition, the bond liner may be applied over an underlying layer of insulation material. Appropriate primers and other surface preparations may be used to prepare the surface for application.

The UV-curable bond liner is then cured by exposing the bond layer to UV light of the appropriate wavelength in the UVA range to initiate polymerization. By irradiating the liner in this region, the initiator is activated without interference from the filler components or heat cured liner components. The wavelength UVA region of the spectrum also enables deeper curing by eliminating interference from the conjugated double-bond systems in the polymers. In general, a layer thickness of 0.07 to 0.09 inches can be cured, but cure thicknesses in excess of 0.1 inches are believed to be possible.

For small rocket motor casings, a 360° UV lamp passed along the axis of the rocket casing should be sufficient to cure the bond liner coating. For large casings, a 180° degree UV lamp passed over the interior surface at a fixed distance can be used.

After the bond liner is fully precured to a slump free state with UV light, the propellant is cast and the propellant and bond liner thermally cured by suitable techniques known in the art. During the cure of the propellant, the heat curable polymer in the bond liner is simultaneously cured to form a bond with the propellant.

### EXAMPLE

Bond liner compositions were made, applied, and cured on various rocket casing materials. A typical composition used in the tests is shown in Table A. Bulk liner testing revealed excellent stress in excess of 300 psi with a maximum observed strain of 50%. The strain was low relative to many thermally cured liner systems, but this level of strain is acceptable in some systems. It is believed that lower strain is driven by the high degree of cross-linking associated with the acrylate polymers. The bondline exhibited excellent propellant/liner/case bond properties. In the tests, Analog Flap Termination samples (AFTs) were used to assess the bondline capability. Tensile data for bonding some common case materials to propellant are shown below in Table B. All samples failed in the propellant (13 non-nitrate ester propellant). Tests were conducted at 0.02 ipm and 150° F.

TABLE A

| Ingredient | Description | Weight % |
|---|---|---|
| CN301 | UV Polymer | 19.75 |
| Irgacure-819 | UV Initiator | 0.25 |
| Hydroxy terminated polybutadiene | Heat Cure Pre-polymer | 25.25 |
| (HTPB) | | |
| IPDI | Isocyanate Curative | 2.75 |
| Isophthaloylbis(2-methylaziridine) | Bonding Agent | 2.00 |
| ATH | Filler | 20.0 |
| Zinc Borate | Filler | 20.0 |
| Silica (Imsil ™ A-8) | Filler | 9.0 |
| Cab-O-Sil ™ | Thixotrope | 2.0 |

TABLE B

| | Tensile |
|---|---|
| Substrate | (psi) |
| Aluminum (grit blasted) | 36.3 |
| Steel (grit blasted) | 47.1 |
| Composite (pattern) | 43.8 |
| Composite (smooth) | 52.1 |

CN301 is an acrylate terminated polybutadiene available from Sartomer, Exton, Pa. Irgacure-819 is phenylbis(2,4,6-trimethylbenzoyl)-phosphone oxide available from Ciba Specialty Chemicals. IPDI is isophorone diisocyanate. DDI is dimeryl diisocyanate. ATH is alumina trihydrate. Imsil™ A-8 is a microcrystalline silica oxide available from Uminin, Japan. Cab-O-Sil is a fumed silica oxide available from Mallinckrodt Baker, Inc.

Alternate formulations were also studied, such as using DDI in the place of IPDI. Larger acrylate polymers such as aromatic urethanes were also found to work well with the UV cure mechanism. Lithium salts, such as lithium carbonate, lithium aluminate, and lithium metal and tetra borates were also found to exhibit good UV transparency, but were difficult to mix with the acrylate polymer.

Zinc salts, some of which are valued from their low signature properties and insulative properties, were investigated for use in UV curable formulations that are curable at UVB frequencies. Since it was found that these salts cannot transmit sufficient light at these frequencies, it was concluded that a UV-curable composition that is curable at a UVB frequency and contains a high amount of these Zn-salt fillers is not practical.

While this invention has been described with reference to certain specific embodiments and examples, it will be recognized by those skilled in the art that many variations are possible without departing from the scope and spirit of this invention, and that the invention, as described by the claims, is intended to cover all changes and modifications of the invention which do not depart from the spirit of the invention.

What is claimed is:

1. A bond liner composition for the manufacture of rocket motors comprising:
an ultraviolet light curable polymer that is curable by exposure to light at a wavelength between about 350 and about 400 nm, a heat curable polymer;
at least 30 weight percent of solid filler that is UV-transmittive at the wavelength at which the ultraviolet light curable polymer is curable.

2. A bond liner composition as in claim 1 wherein there is between about 40 and about 60 weight percent of the solid filler.

3. A bond liner composition as in claim 1 wherein the filler includes one or more of aluminum trihydrate, zinc borate, magnesium salts, or silicon based compounds.

4. A bond liner composition as in claim 1 wherein the filler includes at least one borate and at least one metal oxide present in effective amounts to make said rocket motor liner erosion resistant.

5. A bond liner composition as in claim 1 wherein the ultraviolet light curable polymer includes:
an ultra-violet free-radical initiator that is activated by exposure to light at a wavelength between about 350 and about 400 nm, and
a free radical curable polymer that cross-links when the initiator is activated.

6. A bond liner composition as in claim 5 wherein the free radical curable polymer includes an acrylate polymer.

7. A bond liner composition as in claim 1 wherein the heat curable polymer includes:
a prepolymer comprising at least two reactive hydrogen providing moieties capable of reacting with a multifunctional isocyanate to form urethane or thiourethane linkages, and
a curative reactive comprising a multifunctional isocyanate.

8. A bond liner composition as in claim 7 wherein the hydrogen providing moieties include hydroxy or thiol moieties.

9. A method for applying a bond liner to a rocket motor comprising;
applying upon in the inner surface of a motor casing a layer of an uncured bond liner composition, comprising;
an ultraviolet light curable polymer that is curable by exposure to light at a wavelength between 350 and 400 nm,
a heat curable polymer;
at least 30 weight percent of solid filler that is UV-transmittive at the wavelength at which the ultraviolet light curable polymer is curable.
exposing the layer with UV light at the wavelength at which the ultraviolet light curable polymer is curable for sufficient time to cure the ultraviolet light curable polymer in the bond liner composition.

10. A method for applying a bond liner as in claim 9 wherein an insulation layer is applied to the inner surface of the motor casing before applying the bond liner composition.

11. A rocket motor comprising.
a rocket motor casing;
a bond liner on the inner surface of the casing, which is the cured product of a composition comprising;
an ultraviolet light curable polymer that is curable by exposure to light at a wavelength between 350 and 400 nm,
a heat curable polymer;
at least 30 weight percent of solid filler that is UV-transmittive at the wavelength at which the ultraviolet light curable polymer is curable.
a solid propellant grain bonded to the bond liner within the casing.

12. A rocket motor as in claim 11 wherein there is between about 40 and about 60 weight percent of the solid filler in the bond liner.

13. A rocket motor as in claim 11 wherein the filler includes one or more of aluminum trihydrate, zinc borate, magnesium salts, or silicon based compounds.

14. A rocket motor as in claim 11 wherein the ultraviolet light curable polymer includes:
an ultra-violet free-radical initiator that is activated by exposure to light at a wavelength between 350 and 400 nm, and
a free radical curable polymer that cross-links when the initiator is activated.

15. A rocket motor as in claim 11 wherein the free radical curable polymer includes an acrylate polymer.

16. A rocket motor as in claim 11 wherein the filler includes at least one borate and at least one metal oxide present in effective amounts to make said rocket motor liner erosion resistant.

17. A rocket motor as in claim 11 wherein the heat curable polymer includes:
a prepolymer comprising at least two reactive hydrogen providing moieties capable of reacting with a multifunctional isocyanate to form urethane or thiourethane linkages, and
a curative reactive comprising a multifunctional isocyanate.

18. A rocket motor as in claim 11 wherein the inner surface of the casing has an insulation layer that is disposed between the casing and the bond liner.

19. A method for manufacturing a rocket motor comprising;
applying upon the inner surface of a motor casing a layer of an uncured bond liner composition comprising:
an ultraviolet light curable polymer that is curable by exposure to light at a wavelength between 350 and 400 nm,
a heat curable polymer,
at least 30 weight percent of solid filler that is UV-transmittive at the wavelength at which the ultraviolet light curable polymer is curable;
exposing the layer with UV light at the wavelength at which the ultraviolet light curable polymer is curable for sufficient time to cure the ultraviolet light curable polymer sufficiently to render the bond liner in a slump resistant state;
casting a propellant within the bonder liner coated casing;
cocuring by heat the propellant and the heat curable polymer by heating the motor to form a solid propellant grain bonded to the casing by the bond liner.

20. A method for manufacturing a rocket motor as in claim 19 wherein an insulation layer is applied to the inner surface of the motor casing before applying the bond liner composition.
